(19) United States
(12) Patent Application Publication
(10) Pub. No.: US 2002/0046052 A1
(43) Pub. Date: Apr. 18, 2002

(54) Page content item billing

(76) Inventors: Sean Brown, London (GB); Stig Paaske, Kirke Saaby (DK)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/928,973

(22) Filed: Aug. 14, 2001

(30) Foreign Application Priority Data
Aug. 18, 2000 (GB) 0020368.7
Jul. 12, 2001 (GB) 0116999.4

(51) Int. Cl. G06F 17/60

(52) U.S. Cl. 705/1

(57) ABSTRACT

A method and system is provided for billing for access to individual content items on a downloadable page. Each such item is only downloaded with, or for incorporation into, the rest of the page if selected for access by a user requesting the page. At the time of downloading the item, the server generates an item-dependent billing event.

### FIELD OF THE INVENTION

The present invention relates to billing for access to selectively-accessible individual content items on a page downloaded from a server.

As used herein, the term “page” is used to mean the basic unit of content transmission identified, for example, by a URL, such as a web page or WAP deck.

### BACKGROUND OF THE INVENTION

As Internet Portals become more of a medium through which people access goods and services, as well as information, the content containing such goods, services, and information becomes more valuable. Many service providers are launching portals that aggregate this content from many sources (content providers) and are seeking ways of recovering the costs of obtaining content for aggregation. In effect, service providers are looking to pass on the purchasing costs of the content to the customers who are choosing to consume the content. What is needed is a mechanism facilitating the provision of content to content aggregators for them to re-sell the content to their customers.

Current content billing strategies offer the billing granularity of per session, per site, or per page billing defined as follows:

Per Session: The customer (content consumer) is charged for all data transferred to or from an Internet location (the consumer's current location) for the duration of the TCP (HTTP) session concerned. This approach to billing can be readily implemented by the interrogation of router logs (e.g. Cisco Netflow) with correlation to the session owner's IP address. The main disadvantage is the granularity of what can be billed. Billing will occur against a complete TCP session with aggregation of data transfers up and data transferred down for the session duration. Hence the customer can only be billed by session.

Per Site: The customer (content consumer) is charged for all data transferred from a particular site, such as www.hp.com (15.X.X.X). The disadvantage of this solution is that content can only be rated by site location. If the content provider were to provide to the content aggregator 3 varying types of content, each with a different value (say £1, £2, and £5) then the content aggregator, in order to successfully bill for the content would have to maintain 3 separately addressable web sites (15.X.X.1, 15.X.X.2, 15.X.X.3) and track requests to each site by customer and then aggregate all 15.X.X.3 visits etc.

Per URL: The customer (content consumer) is charged for all data transfer from a web location such as www.hp.com/content1/home.htm. Content is charged by web page with access to each page by the customer being tracked. This is done via the web logs produced by the Web (or WAP) server and is aggregated against requesting IP address. The IP address is then correlated against known customers to whom the IP address had been allocated. This allows content charging to be managed across URLs which is more manageable from a content providers point of view.

It is an object of the present invention to enable a finer granularity in billing for downloaded content.

### SUMMARY OF THE INVENTION

According to the present invention, there is provided a method of billing for access to individual content items on a page downloadable from a server to a user client entity, in which at least one content item on the page is user-selectable for download; the item, following its selection, being downloaded incorporated, or for incorporation, into the associated page and otherwise being absent from the downloaded page; the server generating an item-dependent billing event at the time of at least the first downloading of the item.

According to another aspect of the present invention, there is provided a server system arranged to bill for access to an individual content item on a page downloadable from the server system to a user client entity, the server system comprising:

a content server for serving a user-requested page in which a content item on the page is user-selectable for download;

selection detection means for determining selection by the user of the user-selectable item of the user-requested page; and

control means responsive to the selection detection means detecting selection of said user-selectable item, to cause that item to be downloaded by the content server incorporated, or for incorporation, into the associated page;

billing means for generating an item-dependent billing event at the time of at least the first downloading of the user-selectable content item.

### BRIEF DESCRIPTION OF THE DRAWINGS

A method and system embodying the invention, for billing for access to individual page content items, will now be described, by way of non-limiting example, with reference to the accompanying diagrammatic drawings, in which:

FIG. 1 is a diagram showing a page downloaded from a server and containing place holders for selectively accessible content items;

FIG. 2 is a diagram showing the page of FIG. 1 after selection of one of the selectively-accessible items; and

FIG. 3 is a diagram showing the coding structure of a web page used in one implementation of the invention.

### BEST MODE OF CARRYING OUT THE INVENTION

The billing method now to be described allows for content billing by page item (be it text, a gif or jpeg image, a document, an object etc.) whilst at the same time allowing the content aggregator to produce billing reconciliation records regarding which content providers content has been sold to which customer. The method involves the use of item-related code (written, for example, in ASP or JSP) embedded within the downloadable page to ‘un-lock’ chargeable content items, these items being displayed as place holders until unlocked. When the content is ‘un-locked’ by the customer (content consumer), by selecting the content item, the relevant item-related code writes a billing event to the server log file with information such as requesting IP address, Time of day, Content Tag. The Content Tag, which can be a composite field, includes elements such as content provider ID, content billable rating, and (optionally) content item ID. The place holder for the content item will generally display the value of the content item concerned.

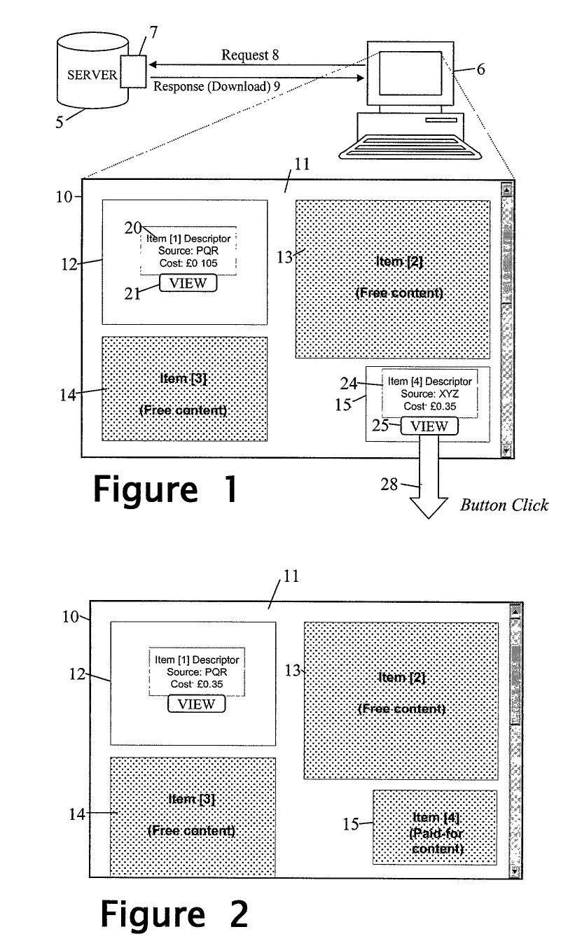

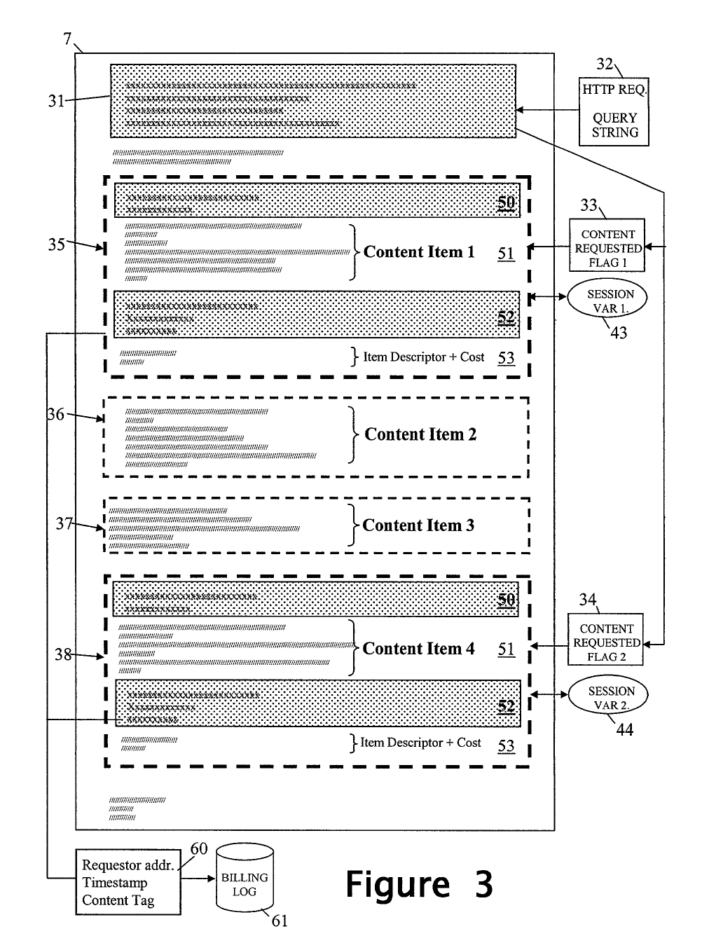

FIG. 1 illustrates the initial downloading of an example web page file 7, from a web server 5 run by a content aggregator, to a client entity 6 (such as a browser application running on a PC), the file being downloaded in an HTTP Response message 9 returned by the server in response to a Request message 8 that identified the page file 7 by URL. The page file is displayed as page 11 in a browser window 10. In the present example, the page 11 is made up of four content areas 12 to 15 intended for content items [1] to [4] respectively. However, only two of these areas contain their related content when the page is first loaded, these being areas 13 and 14 that contain content items [2] and [3] respectively. The items [2] and [3] are “free” items for which the consumer (user of client entity 6) is not billed, these being, for example, provided by the content aggregator.

In contrast, the content areas 12 and 15 do not contain the content for which they are intended but, instead, contain place holders that include item descriptors and an indication of the cost of viewing the items concerned. Thus, content area 12 contains place holder 20 for content item [1], the place holder indicating that item[1] is from source PQR and is accessible at a cost of £0.10. Similarly, content area 15 contains place holder 24 for content item [4], the place holder indicating that the content item [4] is from source XYZ and is accessible at a cost of £0.35.

Each place holder 20/24 has associated item selection functionality, here shown as “View” buttons 21 and 24 respectively, which the content consumer can click to access the corresponding content item for the cost shown. In FIG. 1, arrow 28 indicates that the consumer has decided to view content item [4] and has accordingly clicked button 25. FIG. 2 shows the resultant form of the displayed web page 11, this page being the same page as displayed in FIG. 1 but now with content [4] present in content area 15. What has happened is that clicking button 25 has resulted in a message passing to server 5 which has responded by sending back the missing content item [4] for display; at the same time as downloading content item [4], server 5 generates a billing event which it logs. As already indicated, this event includes items such as requesting IP address, time of day, and content tag, an example event item being:

172.186.34.23|183426GMT|XYZ0035

where the third element is the Content Tag, in this case composed of a combination of the source ID (“XYZ”) and item cost (£0.35).

The structure of an example code implementation will now be outlined with reference to FIG. 2 that shows the page file 7. In this implementation, pressing a content-item View button, results in the page file 7 being downloaded again from the server 5, this time with the selected content item present in the file, rather than its place holder.

The page file 7 contains server-side script blocks interspersed with content code, the script blocks being shown with a grey background. The file is structured with an initial script block 31 that processes the query string 32 (if present) of the HTTP Request message, and four content sections 35 to 38 each associated with a respective content item. When the page file is first requested the query string is empty and block 31 generates, in reset state, “content-requested” flags 33 and 34 in respect of the selectable content items [1] and [4], the reset state corresponding to the item concerned not being requested in the current Request message. Processing then proceeds to generating and downloading the web page file. The free content items [2] and [3] are simply downloaded according to the content code contained in the corresponding content sections 36 and 37. For the selectable content items [1] and [4], the script code in the corresponding content sections 35, 38 determines whether the content item or its placeholder is downloaded, in dependence both on the corresponding content-requested flag 33/34 and on the state of a “content-served” variable 43/44 stored in the user session object for the item. This variable indicates whether the content item, as identified by its content ID, has previously been downloaded to the user during their current session on the website. If this variable is not already stored in the Session object (which it won't be if the page has not been previously loaded during the current session), then it is created by the initial script block 50 of the selectable content section 35, 38, the variable being created in a state indicating that the content item has not been downloaded.

Considering the selectable content sections 35, 38 in more detail, each comprises four blocks, namely:

Block 50—script code for initialising “content-served” variable 43/44 and determining if the content item has been selected either in the current Request or previously in the session if so, block 51 and 52 are processed, otherwise block 53 is processed. In pseudo code:

If “content-served” variable not present, then:

create it in ‘not previously served’ state.

If either the relevant “content-requested flag” is set, or the relevant “content-served indicator” in Session variables collection is set, then:

go to block 51

else

skip to block 53.

Block 51—this is the content item code

Block 52—script code that is processed after the content-item block 51 and is responsible for generating a billing event, and updating the “content-served” variable, if the content item has not been previously loaded. In pseudo code:

If the relevant “content-requested flag” is set but the relevant “content-served indicator” in Session variables collection is not set, then:

set the content-served indicator;

bill for this content item.

Block 53—This is the place holder that is displaced if the content item has not been requested. The code for the View button is also here (this is implemented as an HTML form to be sent back using the GET method upon the View button being pressed, the content item ID being then included in the query string of the resulting Request, this Request being addressed back to the page file 7).

Upon the file 7 receiving an HTTP Request generated in response to a View button (such as button 25) being clicked, the script block 31 sets the “content-requested” flag of the content item requested,—here, flag 34 relating to item [4]. The page file 7 is then further processed for downloading the page to the browser. When block 50 of content section 38 is processed, it determines that its blocks 51 and 52 are to be processed rather than place-holder block 53; as a result, content item [4] is downloaded and a corresponding billing event 60 is generated that is stored in billing log 61. The content-served variable for content item [4] is also set to indicate that the item has been served during the current session.

By setting the content-served variable 44, whenever the page file 7 (or, indeed any other page file containing item [4]) is again requested by the consumer during the current session, the content item [4] will be downloaded (independently of the state of the content-requested flag 34); however, the consumer is not billed again.

The billing information held in log 61 can periodically be:

collected by an IP mediation platform such as the Hewlett-Packard Smart Internet Usage product.

aggregated by content tag to provide billing reconciliation reports between the content aggregator and the content provider.

correlated against requesting IP address that is in-turn correlated against known user (IP to user mapping held within Radius logs etc), the customer can then be billed for individual content items downloaded and this can be listed as items on his/her bill.

Passed as IDR's (Internet Details Records) to a billing engine for rating and billing against subscriber.

It will be appreciated that many variants are possible to the above described implementation. For example, block 52 could be merged into block 50 so that the billing event is generated before processing of content block 51. Furthermore, the record that is maintained of whether a user has previously downloaded a content item can be more persistently maintained than just in the current session object thereby enabling the record to be checked during subsequent sessions so that the user is only billed once for each item independently of the number of downloads of the item. This checking can be done either:

prior to generation of the billing event with the event not being generated if the item has been previously downloaded, or

subsequent to the generation of the billing event with the event being cancelled if the item has been previously downloaded.

Although in the foregoing example, the user makes his/her selection of items in real time whilst the page is displayed, content selection can be made in advance both by specific item and by type, the selection being stored in a database which is accessed by, for example, code block 31 when serving a page, code block 31 setting the content-requested flags for the page as appropriate.

Instead of a selectable content item appearing in full in the page file 7, it can, of course, be included into the page by, for example, embedding as an object.

Other embodiments are, of course possible. For example, the place holder for a content item could be an applet which when activated gets the content item by appropriate communication with the page file 7 on server5, the content item then being incorporated in the page at the browser by the applet.

The content rating (cost) of an item need not be held in the Content Tag. The Content Tag could contain a reference code to a rate table held within the billing engine. For example, instead of XYZ0035 representing Content Provider=XYZ, Rate Value=00.35, the rate value could be resolved within the billing engine (such as Portal Infranet) against a ‘rating table.’ The content tag could then appear like “XYZoag” with the part ‘oag’ corresponding to an item of value of 0.35 pence. This approach would require agreement between content provider and content aggregator/portal owner to determine a mapping of content codes against values; however, the approach does provide a securer solution with some protection against hacking. Potentially PKI certification could be used to ensure complete security of content providers content or the Hewlett-Packard “e-speak” technology can be employed.

Although in the foregoing specific reference has been made to web pages as the container for content items, it will be appreciated that the present invention can equally be applied to other units of content transmission such as WAP decks.

1. A method of billing for access to individual content items on a page downloadable from a server to a user client entity, in which at least one content item on the page is user-selectable for download; the item, following its selection, being downloaded incorporated, or for incorporation, into the associated page and otherwise being absent from the downloaded page; the server generating an item-dependent billing event at the time of at least the first downloading of the item.

2. A method according to claim 1, wherein when first requested by a client entity, the page is downloaded without said at least one content items, the downloaded page including an interface component enabling the user to select a said at least one content item for access, use of this component to select a content item causing the server to download the selected content item either by:
downloading the page again with the content item incorporated, or
downloading the content item in a plug-in for incorporation by the client entity into the previously downloaded page at a location identified in the latter.

3. A method according to claim 2, wherein the originally-downloaded page includes a respective place holder for the or each said at least one content item, the place holder including an item descriptor and an access price indication.

4. A method according to claim 1, wherein the user has pre-selected specific content items and/or content items of a particular type, this pre-selection being stored for access by the server, the server using this pre-selection to determine whether a selectable content item is to be incorporated into a page requested for downloading.

5. A method according to claim 4, wherein the pre-selection is one made during the course of a current user session with the server, the pre-selection being stored in a server session variable for the user.

6. A method according to claim 1, wherein a billing event is only generated the first time the item is downloaded during a user session with the server.

7. A method according to claim 4, wherein the pre-selection is stored in a database with persistence beyond a current user session with the server.

8. A method according to claim 1, wherein a record is maintained of whether a user has previously downloaded a said content item and wherein this record is checked so that the user is only billed once for each item independently of the number of downloads of the item, this checking either being done:
prior to generation of said billing event with the event not being generated if the item has been previously downloaded, or
subsequent to the generation of the billing event with the event being cancelled if the item has been previously downloaded.

9. A method according claim 1, wherein the page is a web page and the server is an HTTP web server.

10. A method according to claim 1, wherein the page is a WAP deck.

11. A server system arranged to bill for access to an individual content item on a page downloadable from the server system to a user client entity, the server system comprising:
a content server for serving a user-requested page in which a content item on the page is user-selectable for download;
selection detection means for determining selection by the user of the user-selectable item of the user-requested page; and
control means responsive to the selection detection means detecting selection of said user-selectable item, to cause that item to be downloaded by the content server incorporated, or for incorporation, into the associated page;
billing means for generating an item-dependent billing event at the time of at least the first downloading of the user-selectable content item.

12. A system according to claim 11, wherein when said page is first requested, the content server is operative to download the page without the user-selectable content item, the downloaded page including an interface component enabling the user to select user-selectable content item for access, use of this component to select a content item causing an indication to be sent to the server system which is detected by the selection detection means resulting in the control means causing the content server to download the content item either by:
downloading the page again with the content item incorporated, or
downloading the content item in a plug-in for incorporation into the previously downloaded page at a location identified in the latter.

13. A system according to claim 11, wherein the user has pre-selected specific content items and/or content items of a particular type, the server system include selection store for storing this pre-selection, and the selection detection means using this pre-selection to determine whether the user-selectable content item is to be incorporated into the user-requested page.

14. A system according to claim 11, wherein the page is a web page and the content server is an HTTP web server.
